(19) United States
(12) Patent Application Publication
(10) Pub. No.: US 2025/0076485 A1
(43) Pub. Date: Mar. 6, 2025

(54) METHODS AND DEVICES FOR PRIORITIZING AN IN PARTICULAR UWB-BASED DISTANCE DETERMINATION

(71) Applicant: Continental Automotive Technologies GmbH, Hannover (DE)

(72) Inventors: Thomas Reisinger, Regenstauf (DE); Alexander Heinrich, Donaustauf (DE)

(73) Assignee: Continental Automotive Technologies GmbH, Hannover (DE)

(21) Appl. No.: 18/290,742

(22) PCT Filed: Jun. 13, 2022
(86) PCT No.: PCT/DE2022/200126

§ 371 Date: Jan. 19, 2024

(30) Foreign Application Priority Data
Jul. 20, 2021 (DE) 10 2021 207 725.0

(51) Int. Cl. G01S 13/76; H04L 51/226; H04W 4/40

(52) U.S. Cl. CPC G01S 13/765; H04L 51/226; H04W 4/40

(57) ABSTRACT

Disclosed is an apparatus for determining at least one distance value, representing a distance between a vehicle transceiver of a vehicle and one of a plurality of mobile device transceivers, by interchanging messages, wherein at least one vehicle transceiver is configured, to prioritize, according to predefined priorities, one or more messages from a first mobile device transceiver over one or more messages from at least one other mobile device transceiver.

The application relates to methods and apparatuses for determining in each case a distance value, representing a distance between a vehicle transceiver of a vehicle and one of a plurality of mobile device transceivers, by interchanging messages.

The determination of a distance between a vehicle transceiver and a mobile device transceiver (e.g. smartphone, smartwatch, ID transponder (e.g. vehicle key, key fob)) by means of UWB ToF (Time of Flight) can be organized e.g. in a so-called “UWB ranging session” which can define, inter alia, the temporal behavior (ranging cycle, repetition rate, etc.) when interchanging messages for distance determination.

In such systems, multiple UWB communications can start at the same time. Here are two scenarios as an example:

A vehicle access system, for example, can consist of a conventional PASE system with a UWB “relay attack” defense system and a smartphone/smartwatch-based system. Here, for example, smartphone tracking using UWB and a RAD distance measurement for an ID transponder could be running at the same time if the smartphone and ID transponder (e.g. in the vehicle key) are located in the access area of a vehicle.

A second scenario of this kind could occur, for example, when a plurality of smartphones are simultaneously located in the access area of the vehicle.

A vehicle transceiver could indeed switch between UWB ranging sessions if their ranging cycles do not overlap. If this is still the case (“resource conflict”), only one session could be served and the ranging cycle of the other sessions may be lost.

A failure rate of ranging results that is possibly caused thereby can affect the quality and latency of localization.

Even if there are multiple UWB communications in an access system, it may be advantageous if the system has a fast response time in order to avoid a “wall effect” (driver notices a delay when unlocking the vehicle and may have to pull the door handle several times).

It can also be advantageous to avoid an unwanted system behavior due to a high failure rate of the ranging results, e.g. constant opening/closing in approach unlock systems (mobile device is located in an unlock zone of a vehicle, but is only localized sporadically due to a high ranging failure rate).

An object of the invention is to optimize a determination of a distance value representing a distance between at least one motor vehicle transceiver of a motor vehicle and one of a plurality of mobile device transceivers outside the motor vehicle. The object is achieved in each case by the subjects of the independent patent claims. Some particularly advantageous embodiments of the invention are specified in the dependent claims and the description.

As alternatives to existing solutions, embodiments of the invention can make it possible to efficiently and reliably determine a distance and/or a time-of-flight between a vehicle and one of a plurality of (mobile device) transceivers.

With respect to some embodiments of the invention according to the dependent claims:

According to one embodiment of the invention, a prioritization instance of the vehicle is designed to instruct vehicle transceivers of the vehicle, in particular all vehicle transceivers provided for determining a distance value, by sending a priority code for each mobile device transceiver, in particular for its ranging session(s), to prioritize messages from a first mobile device transceiver over messages from at least one other mobile device transceiver in accordance with the priorities in the form of priority codes.

According to a further embodiment of the invention, the prioritization instance is designed to define the priority code(s) for each mobile device transceiver, in particular for its ranging sessions, based in particular on situational criteria, in particular:
based on a mobile device transceiver which, in particular with regard to its ranging session(s) and/or messages, has been selected to now be prioritized, and/or
based on the most recently determined distances between the mobile device transceivers and the vehicle, and/or
based on the last mobile device transceiver that locked or unlocked or started the vehicle, and/or
based on the mobile device transceiver that is stored as belonging to the owner of the vehicle, and/or
in the form of a prioritization of mobile device transceivers that alternates in particular in a predefined cycle,
and/or in the form of an increased prioritization of mobile device transceivers newly detected as being in the radio range of the vehicle, and/or
in the form of a reduced prioritization of mobile device transceivers detected as unchanged in terms of their position, and/or
in the form of a reduced prioritization of mobile device transceivers detected as irrelevant to vehicle access.

According to a further embodiment of the invention, the vehicle transceivers are each designed to use the priority codes for at least one mobile device transceiver that are respectively sent to them by the prioritization instance to prioritize messages from at least one first mobile device transceiver over messages from at least one other mobile device transceiver in accordance with the predefined priority codes,
in particular at least as long as the vehicle transceivers do not change at least one priority code according to priority rules stored in them.

According to a further embodiment of the invention, the priority codes define one or more of the following possibilities:
no prioritization by assigning the same priority code to all messages and/or ranging sessions and/or mobile device transceivers, and/or
prioritization of individual messages and/or ranging sessions and/or mobile device transceivers by assigning a comparatively lower priority code, and/or
deprioritization of individual messages and/or ranging sessions and/or mobile device transceivers by assigning a higher priority code than before, and/or
prioritization in a unique priority order by assigning different priority codes to all messages and/or ranging sessions and/or mobile device transceivers, and/or
dynamic change in the assignment of at least one priority code by changing it during a running ranging session of a mobile device transceiver.

According to a further embodiment of the invention, the vehicle transceivers of the vehicle are designed, in accordance with consistent priority rules stored in the vehicle transceivers, to change the (specification of a) priority consistently, in particular in the form of a priority code of one or more of the mobile device transceivers and/or ranging sessions,
in particular in the case of predictively determined or unforeseen resource conflicts and/or message (partial) overlaps when interchanging, in particular receiving, messages from a plurality of the mobile device transceivers.

According to a further embodiment of the invention, each vehicle transceiver of the vehicle is designed, in accordance with consistent priority rules stored in the vehicle transceivers, to change the (specification of a) priority consistently, in particular in the form of a priority code of one or more of the mobile device transceivers, taking into account one or more of the following parameters:
the priority code of the mobile device transceivers and/or ranging sessions and/or messages,
the time sequence of ranging sessions and/or messages of the mobile device transceivers, in particular on a sequence basis or first-come-first-served basis.

According to a further embodiment of the invention, at least one mobile device transceiver is a cellphone or a smartphone or a smartwatch or a watch or an ID transponder.

According to a further embodiment of the invention, messages for determining the distance value are interchanged by means of UWB or UltraWideBand.

According to a further embodiment of the invention, a distance value is or represents a time-of-flight and/or a calculated distance.

According to a further embodiment of the invention, the apparatus, in the event of a prioritization of a message over a further message, is designed to reject the further message, in particular under predefined conditions such as a partial overlap and/or overlap and/or an excessively short time interval between the messages and/or other conditions.

Further features and advantages of some advantageous embodiments of the invention result from the following description of several exemplary embodiments of the invention with reference to the drawing.

To illustrate several possible embodiments of the invention, in the schematic simplified figures:

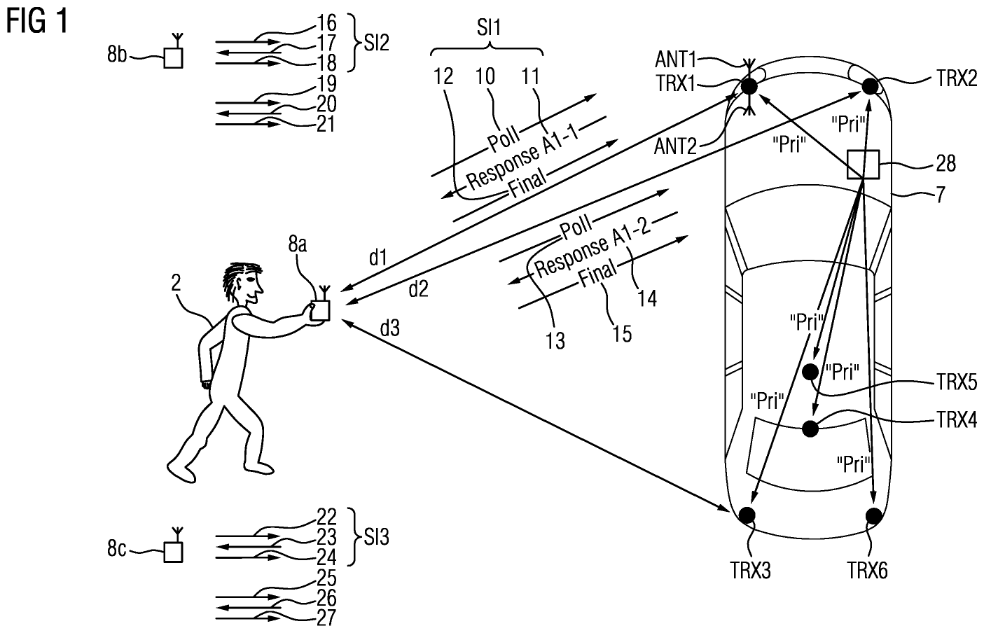

FIG. 1 shows an embodiment according to the invention of a transmission of messages between mobile device transceivers and vehicle transceivers for distance determination,

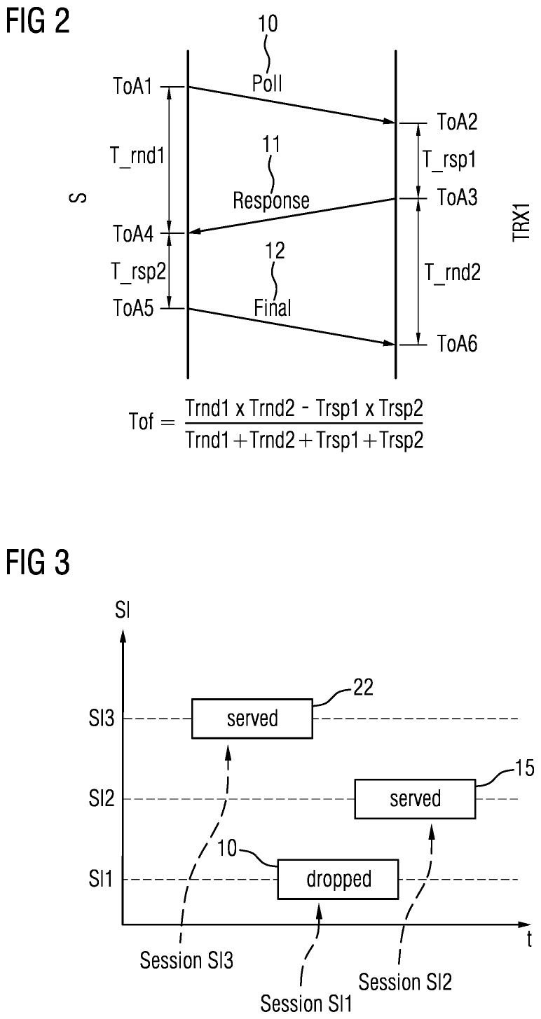

FIG. 2 shows an embodiment according to the invention of a distance determination based on the interchange of e.g. three messages and here optionally also of send/receive times in a simple ranging session,

FIG. 3 shows an embodiment according to the invention of a rejection of a middle message of three due to a first-serve priority for the receipt times of messages,

FIG. 3 shows an embodiment according to the invention of a rejection of a message due to a first-serve prioritization for the receipt times of messages,

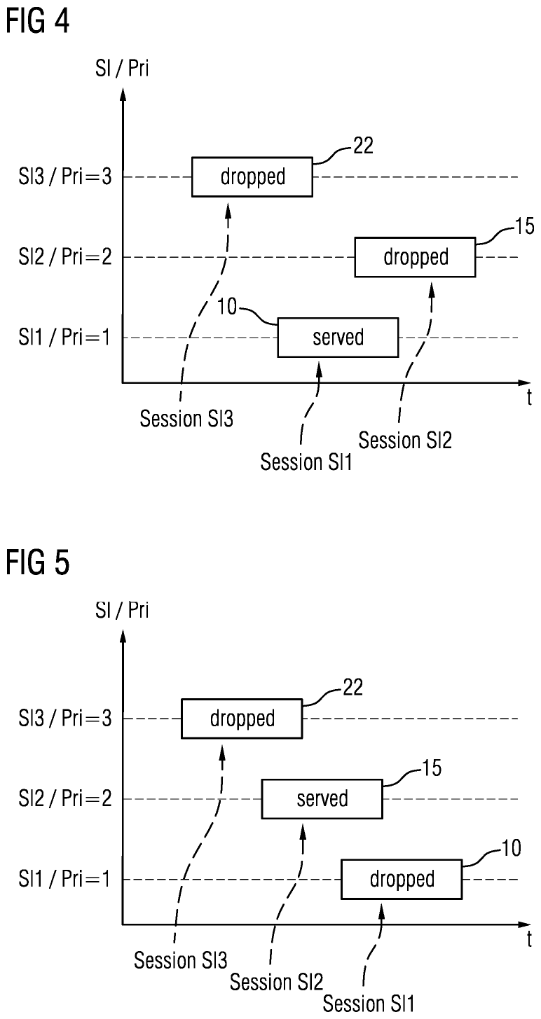

FIG. 4 shows an embodiment according to the invention of a rejection of two messages due to a prioritization of sessions or messages or mobile device transceivers,

FIG. 5 shows an embodiment according to the invention of predictive planning and a rejection of two messages due to a prioritization of sessions or messages or mobile device transceivers and a first-serve prioritization for the receipt times of messages,

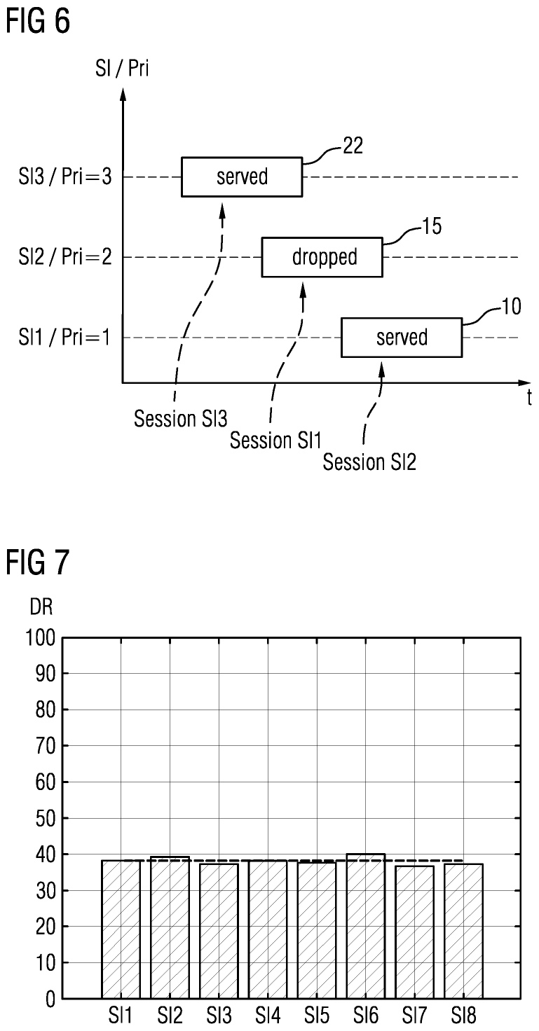

FIG. 6 shows an embodiment according to the invention of predictive planning and a rejection of a message due to a prioritization of sessions or messages or mobile device transceivers and a first-serve prioritization for the receipt times of messages,

FIG. 7 shows examples of message failure rates (e.g. by rejection) with the same prioritization of sessions or messages or mobile device transceivers,

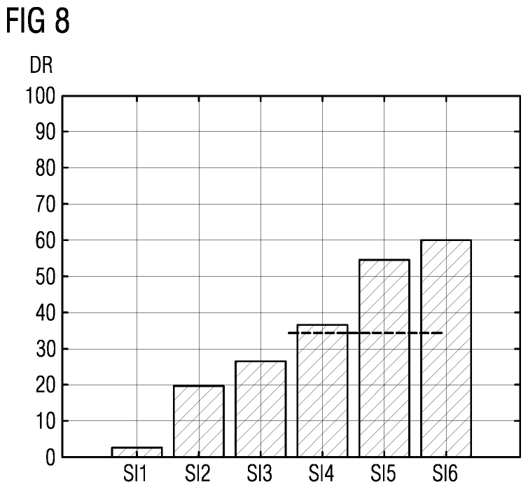

FIG. 8 shows examples of message failure rates (e.g. by rejection) with different prioritization.

FIG. 1 shows, by way of example, how (according to DE102019211152, the disclosure of which is part of this application by reference) there is an interchange, between one (TRX1) of a plurality of vehicle transceivers (TRX1, TRX2, TRX3, TRX4, TRX5, TRX6) of a (motor) vehicle 7 and a first mobile device transceiver 8a (e.g. cellphone, smartphone, smartwatch, watch, ID transponder (motor vehicle key/key fob etc.)
belonging to a user 9, of messages 10, 11, 12, 13, 14, 15 (using e.g. UWB/UltraWideBand)
in order to determine at least one value d1 (e.g. distance d1 or message time-of-flight) representing a distance d1 between the mobile device transceiver 8a and the vehicle transceiver TRX1.

Correspondingly, messages 13, 14, 15 may possibly also be interchanged between one (TRX2) further transceiver of a plurality of vehicle transceivers of the (motor) vehicle 7 and the first mobile device transceiver 8a (e.g. UWB/UltraWideBand)
in order to determine a value d2 (e.g. distance d2 or message time-of-flight) representing a distance d2 between the mobile device transceiver 8a and the vehicle transceiver TRX1.

Opening (or closing) of at least one door or starting of the vehicle 7 can take place, for example, if one or more distances d1, d2 or d1-d8 etc. fall below a value (or exceed a value for closing) and/or distances decrease over time and/or possibly other criteria are met.

As in FIG. 1, another mobile device transceiver 8b (illustrated in simplified form with an antenna) can be within range of the vehicle 7 and can attempt (e.g. automatically or on request) to interchange messages 16, 17, 18, 19, 20, 21 with one or here more vehicle transceivers (TRX1, TRX2, TRX3, TRX4, TRX5, TRX6) in order to determine its own distances from them.

As in FIG. 1, (at least) another mobile device transceiver 8c (illustrated in simplified form with an antenna) can possibly be within range of the vehicle 7 and can attempt (e.g. automatically or on request) to interchange messages 22, 23, 24, 25, 26, 27 with one or here more vehicle transceivers (TRX1, TRX2, TRX3, TRX4, TRX5, TRX6) (e.g. in a message sequence/session referred to in FIG. 2 with poll and/or response and/or final) in order to determine its own distances etc. from them.

Communications with the different vehicle transceivers and/or the different mobile device transceivers can be distinguished, for example, on the basis of different IDs or headers contained in messages depending on the transceiver and/or on the basis of predefined time slots or in another manner.

As illustrated in FIG. 2, for example, total times-of-flight ToF and possibly thus (d=c/ToF) distances d1 etc can be calculated (e.g. in a vehicle transceiver and/or correspondingly also in a mobile device transceiver) on the basis of the times at which the individual messages 10, 11, 12 etc. (correspondingly other messages) were sent and received, in particular when (some/mutual) send and/or receive times are transmitted between the mobile device transceiver 8a and the vehicle transceiver TRX1, with the formula indicated in FIG. 2. This distance calculation can be particularly reliable. Such a method is also called “ranging”.

The three messages 10, 11, 12, for example in FIG. 2, which are transmitted (between a mobile device transceiver 8a and a vehicle transceiver TRX1) and can be used to calculate a distance value d1 are referred to, for example, as a session with a session index SI or SI1.

In FIG. 1, for example, the messages 10, 11, 12 (from the first mobile device transceiver 8a) thus form a session with the session index SI1, the messages 16, 17, 18 (from the second mobile device transceiver 8b) form a session with the session index SI2, and the messages 22, 23, 24 (from the second mobile device transceiver 8b) form a session with the session index SI3.

The determination of a distance between a vehicle transceiver and a mobile device transceiver (e.g. smartphone, smartwatch, ID transponder (e.g. vehicle key, key fob)) by means of e.g. UWB ToF (Time of Flight) can be organized e.g. in a so-called ranging session or “UWB ranging session” which can define, inter alia, the temporal behavior (ranging cycle, repetition rate) when interchanging messages for distance determination.

As explained in FIG. 1, in addition to the mobile device transceiver 8a, at least one further mobile device transceiver 8b and/or 8c can be within range of the vehicle 7 and can attempt (e.g. automatically or on request) to interchange messages with the vehicle transceivers (TRX1, TRX2, TRX3, TRX4, TRX5, TRX6) in order to determine its own distances from them (and to open the vehicle).

For example, if the mobile device transceivers 8a, 8b, 8c etc. are not necessarily synchronized with each other according to all possible embodiments,
it may be the case that the mobile device transceivers 8a, 8b, 8c send messages in a mixed-up and/or partially overlapping manner and/or in excessively quick succession, which messages can then arrive at at least one vehicle transceiver in a (partially) overlapping manner, as in FIGS. 3-6, which may possibly also be determined in advance (at least in some cases) by the vehicle transceivers TRX1, TRX2, TRX3, TRX4, TRX5, TRX6 (e.g. if the protocol/sequence is sufficiently defined).

FIG. 3 shows, against the time t shown to the right, three messages arriving at one (e.g. TRX1) of the vehicle transceivers (TRX1, TRX2, TRX3, TRX4, TRX5, TRX6), namely the message 10 (from the first mobile device transceiver 8a), the message 15 (from the second mobile device transceiver 8b) and the message 22 (from the third mobile device transceiver 8c), that is to say here messages from three mobile device transceivers 8a, 8b, 8c.

In some embodiments, the vehicle transceiver TRX1 could not or could suboptimally be able to process these messages 22, 15, 10, which arrive in a (partially) overlapping manner or in excessively quick succession, e.g. from different mobile device transceivers 8a, 8b, 8c, sufficiently quickly and/or to switch over between processing and, if necessary, answering the (ranging) messages 22, 15, 10 in the various sessions SI1, SI2, SI3 in order to ensure reliable ranging (for distance determination).

Thus, according to embodiments of the invention, some of the messages (22, 10, 15 in FIG. 3) that arrive at a vehicle transceiver (TRX1) in a (partially) overlapping manner or in excessively quick succession can be rejected (ignored).

Which of the messages (22, 10, 15 in FIG. 3) arriving at a vehicle transceiver (TRX1) too close together or in a (partially) overlapping manner are rejected, can be defined (in advance), according to embodiments of the invention, for example, by prioritizing the messages differently with a predefined priority, wherein, for example, messages with a lower priority (e.g. with a higher priority code of two instead of one) than other messages (and/or later messages) can be rejected or ignored and/or the distance determination and/or session associated with these messages is respectively currently not continued.

The prioritization of messages 10-27 (messages 22, 15, 10 in FIG. 3) relative to each other can be carried out, for example, in the following different embodiments of the invention:

For example, the predefined prioritization can include the priority rule of (or, as in FIG. 3, involve) giving the messages that arrive before one or more further messages arrive (at a vehicle transceiver) a higher priority (i.e. not rejecting/ignoring them but using them for distance determination/session) and rejecting/ignoring one or more later message(s) that arrive(s) (in a partially overlapping or overlapping manner or shortly after).

In other words, according to a so-called first-come-first-served principle as a simple example of a predefined priority.

In FIG. 3, for example, a message 22 arrives at a vehicle transceiver TRX1 before the messages 10, 15, and the message 10 arrives after the message 22 (more quickly than a specification or in a partially overlapping manner here), but the message 15 arrives completely after 22 and in a partially overlapping manner only with the message 10.

The message 10 in FIG. 3 is thus rejected (as the only one), because, according to this embodiment of the invention, the priority is determined only by the priority rule of the time order (first come first served, FIFO). (In this case, the individual sessions SI1, SI2, S3 and thus their messages all have the same priority.)

After the message 10 has been rejected, the message 15 no longer overlaps an unrejected message, that is to say it is not rejected.

The order in which the messages 22, 10, 15 arrive can be calculated by the vehicle transceivers beforehand on the basis of a protocol and the prioritizations, i.e. also which message(s) must rejected.

All vehicle transceivers TRX1, TRX2, TRX3, TRX4, TRX5, TRX6 expediently operate independently according to the same priority rules, with the result that e.g. (ranging) sessions or messages of the mobile device transceivers 8a-8c can be processed by all vehicle transceivers in the same order. In addition to individual messages to be rejected, all messages from (ranging) sessions belonging to these individual messages can also be immediately rejected/ignored by all vehicle transceivers or alternatively not.

The prioritization instance 28 of the vehicle 7 sends (in a wired manner or by radio) e.g. priority code(s) of in each case one or more of the sessions SI1, SI2, SI3 (and/or the mobile device transceivers 8a, 8b, 8c and/or the messages) to the vehicle transceivers TRX1, TRX2, TRX3, TRX4, TRX5, TRX6 of the vehicle 7 which are provided for determining a distance value (d1 or d2 etc.) and then prioritize the messages (of the sessions/mobile device transceivers) accordingly.

A prioritization instance 28 in the vehicle (e.g. in a central controller or one of the transceivers) is designed, for example, to define the priority code(s) “Pri” for each mobile device transceiver and/or for a session based in particular on situational criteria,
in particular based on a mobile device transceiver that is intended to be selected to now be prioritized,
and/or based on previously determined distances d1, d2, d3 between the mobile device transceivers 8a, 8b, 8c and the vehicle 7,
and/or based on the last mobile device transceiver 8a, 8b, 8c that locked or unlocked the vehicle 7,
and/or based on the last mobile device transceiver 8a, 8b, 8c that is stored as belonging to the owner 2 of the vehicle 7,
and/or in the form of a prioritization of mobile device transceivers 8a, 8b, 8c that alternates in particular in a predefined cycle (e.g. 1 second, etc.),
and/or in the form of an increased prioritization of mobile device transceivers 8a, 8b, 8c newly detected as being in the radio range of the vehicle 7,
and/or in the form of a reduced prioritization of mobile device transceivers 8a, 8b, 8c detected as unchanged in terms of their position,
and/or in the form of a reduced prioritization of mobile device transceivers 8a, 8b, 8c detected as irrelevant to vehicle access (e.g. blocked or not permitted for the vehicle 7).

FIG. 4 illustrates a further embodiment of the invention, in which, for a plurality of sessions SI1, SI2, SI3 (and thus in each case for all messages including 22, 15, 10 of the sessions), different priorities relative to each other have been defined by a priority instance 28 (e.g. in a control unit) in the form of a priority code Pri (e.g. Pri=“1” (one) for session 1, Pri=“2” (two) of lower priority for session 2, Pri=“2” (two) for session 3).

The priority instance 28 sends (in a wired manner or by radio) this/these priority code(s) “Pri” of one or more of the sessions SI1, SI2, SI3 (and/or mobile device transceivers 8a, 8b, 8c) to the/all vehicle transceivers TRX1, TRX2, TRX3, TRX4, TRX5, TRX6 of the vehicle 7 which are provided for determining a distance value (d1 or d2 etc.) and accordingly prioritize messages (of the sessions and/or mobile device transceivers 8a, 8b, 8c), i.e. reject (ignore) them or do not reject them (i.e. evaluate them for distance determination) in the event of a temporal collision (partial overlap or in excessively quick succession etc.).

In FIG. 4, the priority is therefore not determined here by the message order (first come first served, FIFO). Here, the or some of the individual sessions SI1, SI2, S3 and thus their messages have a different priority, i.e. messages 10, 11, 12 of the session SI1 with the priority code Pri=“1” (one) have the highest priority, messages 16, 17, 18 of the session SI2 with the priority code Pri=“2” (two) have a lower priority in comparison (with 10, 11, 12), and messages 22, 23, 24 of the session SI3 likewise with the priority code Pri=“2” (two) have a lower priority in comparison (with 10, 11, 12).

If the messages 22, 10, 15 thus arrive at transceivers in FIG. 4 in a partially overlapping manner/in an overlapping manner/in excessively quick succession in a manner colliding with each other in time (possibly foreseeable by the vehicle transceivers),
the messages 22 and 15 with the higher priority code (Pri2=priority two) than the priority code Pri (Pri1=priority one) of the message 10 are rejected, but the message 10 is not rejected (that is, it is used further for distance determination).

FIG. 5 illustrates a further embodiment of the invention, in which, for a plurality of sessions SI1, SI2, SI3 (and thus in each case for all messages including 22, 15, 10 of the sessions), different priorities relative to each other have been defined by a priority instance 28 (e.g. in a control unit) in the form of a priority code Pri (e.g. Pri=“1” for session 1, Pri=“2” of lower priority for session 2, Pri=“3” of even lower priority for session 3).

In the exemplary embodiment in FIG. 5, a decision is additionally (also) made in advance (by the vehicle transceivers TRX1 etc.) about a rejection depending on the next message of a session predicted by the vehicle transceiver (on the basis of protocol details), i.e. here, for example, the predicted message 22 of the session SI3 and the predicted message 15 of the session SI2.

The predicted message 22 of the session SI3 is rejected due to a worse priority code Pri=3 than that of the predicted message 15 of the session SI2 (priority code Pri=2).

The conflict with the message 10 of the session SI1 was not predicted here, that is to say the message 10 of the session SI1 is rejected according to this embodiment despite the better priority Pri=1 (in comparison with the priority code Pri=2 of the message 15 of the session SI2) (according to priority rules stored identically in the transceivers).

FIG. 6 also illustrates an embodiment of the invention, in which, for a plurality of sessions SI1, SI2, SI3 (and thus in each case for all messages including 22, 15, 10 of the sessions), different priorities relative to each other have been defined by a priority instance 28 (e.g. in a control unit) (and have been communicated to the vehicle transceivers) in the form of a priority code Pri (e.g. Pri=“1” for session 1, Pri=“2” of lower priority for session 2, Pri=“3” for session 3).

The predicted message 15 of the session SI2 is rejected due to a ((partial) overlap and) worse priority code Pri=2 than that of the predicted message 10 of the session SI1 (priority code Pri=1).

The predicted message 22 of the session SI3 then no longer collides (because the message 15 was rejected), that is to say it is not rejected.

This order of checking (check highest priority 1 first) is a possible embodiment according to the invention of a priority rule which can be implemented in all vehicle transceivers TRX1, TRX2, TRX3, TRX4, TRX5, TRX6 used, i.e. can be executed in the same way in all transceivers, especially in the event of conflicts (such as partial overlap or arrival of messages in excessively quick succession etc.).

Priority rules consistently stored in the vehicle transceivers (TRX) can provide, for example according to embodiments of the invention, for the specification of a priority in the form of, inter alia/in particular, a priority code of messages from one or more of the mobile device transceivers 8a, 8b, 8c and/or sessions to be changed (to a then updated specification of a priority in the form of, inter alia/in particular, a priority code) taking into account in particular one or more of the following parameters:
the priority code Pri of the mobile device transceivers 8a, 8b, 8c and/or the ranging sessions SI1, SI2, SI3 of the mobile device transceivers 8a, 8b, 8c,
the time sequence of ranging sessions SI1, SI2, SI3 of the mobile device transceivers 8a, 8b, 8c, in particular on a first-come-first-served basis.

FIG. 7 shows similar failure rates DR in sessions SI1-S18 of mobile device transceivers 8a, 8b, 8c etc. with the same prioritization of the sessions SI1-SI8.

FIG. 8 shows different failure rates DR in sessions SI1-SI8 and thus e.g. mobile device transceivers 8a, 8b, 8c etc. with different prioritization of sessions.

Instead of, as in some embodiments of the invention
(in the rangings SI1, SI2, SI3 with respect to each other), different “poll”/“final” messages (10, 13, 16, 22; 12, 15, 21, 27), these can alternatively also be the same (10=13=16=22 etc; 12=15=21=27 etc), especially as e.g. a broadcast, and the “response” message can only differ e.g. in SI1, SI2, SI3 (11, 14, 17, 23 differ from each other).

1. An apparatus for determining at least one distance value, representing a distance between a vehicle transceiver of a vehicle and one of a plurality of mobile device transceivers, by interchanging messages, comprising:
at least one vehicle transceiver, configured to prioritize, according to predefined priorities, one or more messages from a first mobile device transceiver over one or more messages from at least one other mobile device transceiver.

2. The apparatus as claimed in claim 1, wherein a prioritization instance of the vehicle is configured to instruct vehicle transceivers of the vehicle, by sending at least one priority code for each mobile device transceiver and/or for its ranging session(s), and
to prioritize messages from a first mobile device transceiver over messages from at least one other mobile device transceiver in accordance with the priorities in a form of priority codes.

3. The apparatus as claimed in claim 2, wherein the prioritization instance is configured to define the priority code(s) for each mobile device transceiver and/or for ranging sessions based on situational criteria.

4. The apparatus as claimed in claim 2,
wherein the vehicle transceivers are each configured
to use the priority codes for at least one mobile device transceiver that are respectively sent to them by the prioritization instance
to prioritize messages from at least one first mobile device transceiver over messages from at least one other mobile device transceiver in accordance with the predefined priority codes,
in particular at least as long as the vehicle transceivers do not change at least one priority code according to priority rules stored in them.

5. The apparatus as claimed in claim 1,
wherein the priority codes define one or more of following:
no prioritization by assigning the same priority code to all messages and/or ranging sessions and/or mobile device transceivers, and/or
prioritization of individual messages and/or ranging sessions and/or mobile device transceivers by assigning a comparatively lower priority code, and/or
deprioritization of individual messages and/or ranging sessions and/or mobile device transceivers by assigning a higher priority code than before, and/or
prioritization in a unique priority order by assigning different priority codes to all messages and/or ranging sessions and/or mobile device transceivers, and/or
dynamic change in the assignment of at least one priority code by changing it during a running ranging session of a mobile device transceiver.

6. The apparatus as claimed in claim 1,
wherein the vehicle transceivers of the vehicle are configured,
in accordance with consistent priority rules stored in the vehicle transceivers, to change the priority consistently, as a priority code of one or more of the mobile device transceivers and/or ranging sessions,
in case of predictively determined or unforeseen resource conflicts and/or message overlaps when interchanging messages from a plurality of the mobile device transceivers.

7. The apparatus as claimed in claim 1,
wherein each vehicle transceiver of the vehicle is configured,
in accordance with consistent priority rules stored in the vehicle transceivers, to change the priority consistently, as a priority code of one or more of the mobile device transceivers, taking into account one or more of the following parameters:
the priority code of the mobile device transceivers and/or ranging sessions and/or messages,
a time sequence of ranging sessions and/or messages of the mobile device transceivers, on a sequence basis or first-come-first-served basis.

8. The apparatus as claimed in claim 1,
wherein at least one mobile device transceiver is a cellphone or a smartphone or a smartwatch or a watch or an ID transponder.

9. The apparatus as claimed in claim 1,
wherein messages for determining the distance value are interchanged by means of UWB or UltraWideBand.

10. The apparatus as claimed in claim 1,
wherein a distance value is or represents a time-of-flight and/or a calculated distance.

11. The apparatus as claimed in claim 1,
which, in an event of a prioritization of a message over a further message, is configured to reject the further message, under predefined further conditions such as a partial overlap and/or overlap and/or an excessively short time interval between the messages.

12. A method for determining at least one distance value, representing a distance between a vehicle transceiver of a vehicle and one of a plurality of mobile device transceivers, by interchanging messages, comprising
using an apparatus as claimed in claim 1,
wherein at least one vehicle transceiver prioritizes, according to predefined priorities for one of the mobile device transceivers and/or one of ranging sessions, messages from a first mobile device transceiver over messages from at least one other mobile device transceiver.

13. The apparatus as claimed in claim 2, wherein vehicle transceivers comprise all vehicle transceivers provided for determining a distance value.

14. The apparatus as claimed in claim 3, wherein the situational criteria comprise at least one of:
mobile device transceiver which has been selected to now be prioritized,
most recently determined distances between the mobile device transceivers and the vehicle, insofar as the mobile device transceiver at the shortest distance from the vehicle has the highest priority,
last mobile device transceiver that locked or unlocked or started the vehicle,
the mobile device transceiver that is stored as belonging to an owner of the vehicle,
a prioritization of mobile device transceivers that alternates,
an increased prioritization of mobile device transceivers newly detected as being in a radio range of the vehicle,
a condition that the mobile device transceiver which is closest to the vehicle or door is prioritized or which most likely triggers an action on the vehicle must be prioritized,
a prioritization depending on a motion profile of a mobile device,
an event triggered UWB ranging request from a first device is given a higher priority than a tracking function of a second device,
a reduced prioritization of mobile device transceivers detected as unchanged in terms of their position, and
a reduced prioritization of mobile device transceivers detected as irrelevant to vehicle access.

15. The apparatus as claimed in claim 14, wherein the mobile device transceiver has been selected to now be prioritized, has been selected with regard to its ranging session and/or messages.

16. The apparatus as claimed in claim 14, wherein the prioritization of mobile device transceivers that alternates, alternates in a predefined cycle.

17. The apparatus as claimed in claim 14, wherein the event is at least one of door handle actuation, radio key actuation pace function.

18. The apparatus as claimed in claim 14, wherein the first device is an ID transponder and/or the second device is a smart phone.
